(19) United States
(12) Patent Application Publication
(10) Pub. No.: US 2026/0285682 A1
(43) Pub. Date: Sep. 24, 2026

(54) HEXAGONAL BORON NITRIDE POWDER AND METHOD FOR PRODUCING SAME

(71) Applicant: TOKUYAMA CORPORATION, Yamaguchi (JP)

(72) Inventor: Shota DAIKI, Yamaguchi (JP)

(21) Appl. No.: 19/475,151

(22) PCT Filed: Feb. 27, 2024
(86) PCT No.: PCT/JP2024/007002

§ 371 Date: Oct. 14, 2025

(30) Foreign Application Priority Data
Apr. 26, 2023 (JP) 2023-072703

(51) Int. Cl. C01B 21/064; C09K 5/14

(52) U.S. Cl. CPC C01B 21/0645; C09K 5/14; C01P 2002/76; C01P 2004/61

(57) ABSTRACT

It is an object of an aspect of the present invention to realize hexagonal boron nitride powder that has high crystallinity and improves thermal conduction properties of resin. In order to attain the object, hexagonal boron nitride powder in accordance with an aspect of the present invention has a ratio of a spectral intensity at a wavelength of 227 nm to a spectral intensity at a wavelength of 330 nm of not less than 1.0, as measured by a cathodoluminescence (CL) method.

### TECHNICAL FIELD

The present invention relates to hexagonal boron nitride powder and a method for producing the same.

### BACKGROUND ART

Recently, with the miniaturization and advanced power capabilities of electronic components, an increase in an amount of heat generated in electronic components has become a problem. As such, in order to efficiently dissipate heat from electronic components, materials having excellent thermal conduction properties have been developed.

Hexagonal boron nitride powder, when mixed with resin used for electronic components, improves thermal conduction properties of the resin. As such, research and development of hexagonal boron nitride powder as a thermally conductive filler is actively conducted. For example, Patent Literature 1 discloses a high-purity hexagonal boron nitride single crystal having an intrinsic ultraviolet emission band at wavelengths of not more than 235 nm.

### CITATION LIST

### Patent Literature

### [Patent Literature 1]

Japanese Patent Application Publication, Tokukai, No. 2005-145788

### SUMMARY OF INVENTION

### Technical Problem

The above high-purity hexagonal boron nitride single crystal is a single crystal unaffected by impurities. However, hexagonal boron nitride powder having high crystallinity has not yet been reported. Research and development is desired for hexagonal boron nitride powder that has high crystallinity and improves thermal conduction properties of resin.

It is an object of an aspect of the present invention to realize hexagonal boron nitride powder that has high crystallinity and improves thermal conduction properties of resin.

### Solution to Problem

In order to attain the object, hexagonal boron nitride powder in accordance with an aspect of the present invention is hexagonal boron nitride powder having a ratio of a spectral intensity at a wavelength of 227 nm to a spectral intensity at a wavelength of 330 nm of not less than 1.0, as measured by a cathodoluminescence (CL) method.

Further, a method for producing hexagonal boron nitride powder in accordance with an aspect of the present invention is a method for producing hexagonal boron nitride powder, the method including:
(1) a reduction nitridation step of obtaining hexagonal boron nitride by heating a raw material mixture in a furnace under a nitrogen atmosphere to a temperature of not less than 1500° C. and not more than 1850° C. at a heating rate of not more than 10° C./min, the raw material mixture containing an oxygen-containing boron compound, a carbon source, an oxygen-containing calcium compound, and a carbon-containing boron compound;
(2) an acid cleaning step of cleaning, with acid, the hexagonal boron nitride powder which has been obtained through the reduction nitridation step and which contains an unreacted raw material;
(3) a heating step in which the hexagonal boron nitride powder after the acid cleaning step is heated to a temperature of more than 1850° C. and less than 2050° C. at a heating rate of not more than 5° C./min;
(4) a cooling step in which the hexagonal boron nitride powder after the heating step is cooled at a cooling rate of not more than 5° C./min to a temperature of at least 1550° C.; and
(5) a recovery step in which the hexagonal boron nitride powder which has been cooled to a temperature of not more than 50° C. is removed from the furnace after the cooling step.

### Advantageous Effects of Invention

An object of an aspect of the present invention makes it possible to realize hexagonal boron nitride powder that has high crystallinity and improves thermal conduction properties of a resin composition filled with the hexagonal boron nitride powder.

### BRIEF DESCRIPTION OF DRAWINGS

FIG. 1 is a view illustrating results of measurement of a CL spectrum in an embodiment of hexagonal boron nitride powder of the present invention.

### DESCRIPTION OF EMBODIMENTS

Note that the expression “A to B” herein means “not less than A and not more than B” unless otherwise specified in this specification.

### [Hexagonal Boron Nitride Powder]

Hexagonal boron nitride powder in accordance with an aspect of the present invention has a ratio of a spectral intensity at a wavelength of 227 nm to a spectral intensity at a wavelength of 330 nm as measured by a cathodoluminescence method (a ratio of a CL spectral intensity at 227 nm to a CL spectral intensity at 330 nm) of not less than 1.0.

The inventors of the present invention conducted a detailed study on hexagonal boron nitride powder and successfully obtained novel findings. Specifically, the inventors of the present invention made a unique discovery that by adopting specific conditions during the production of hexagonal boron nitride powder, it is possible to obtain hexagonal boron nitride powder that has a ratio of a CL spectral intensity at 227 nm to a CL spectral intensity at 330 nm of not less than 1.0. The inventors of the present invention also made a unique discovery that this hexagonal boron nitride powder has high crystallinity and is nearly a single crystal. Furthermore, the inventors of the present invention made a unique discovery that this hexagonal boron nitride powder improves the thermal conduction properties of resin and is suitable as a heat-dissipating filler.

The cathodoluminescence method is a technique for detecting light emitted when an electron beam is applied to a sample. Cathodoluminescence reflects properties of the sample as a crystal, such as crystal defects, impurities, carrier concentration, stress, and others. A CL spectrum at a wavelength of 227 nm is a spectrum indicating high crystallinity. A CL spectrum at a wavelength of 330 nm is a spectrum attributed to carbon impurities. A CL spectral intensity may be a peak intensity of a CL spectrum.

The measurement device used in the cathodoluminescence method may be a known measurement device.

In terms of higher crystallinity and further improvement of the thermal conduction properties of resin, the ratio of a CL spectral intensity at 227 nm to a CL spectral intensity at 330 nm is preferably not less than 1.1, more preferably not less than 1.2, and even more preferably not less than 1.3.

It is preferable that an amount of boron eluted from the hexagonal boron nitride powder be not more than 250 ppm in terms of B₂O₃, as measured after the hexagonal boron nitride powder is immersed in a 2 mol/L aqueous sulfuric acid solution at 25° C. for 120 minutes. The amount of boron eluted correlates with a surface oxygen concentration of the hexagonal boron nitride powder. In a case where the amount of boron eluted is not more than 250 ppm, the oxygen concentration on the powder surface is low, and the crystallinity of the hexagonal boron nitride powder is increased. The amount of boron eluted can be measured, for example, with use of inductively coupled plasma (ICP) emission spectrometry. The amount of boron eluted may be not more than 200 ppm or may be not more than 180 ppm.

An average particle diameter of the hexagonal boron nitride powder is preferably not less than 2 μm, more preferably not less than 5 μm, and even more preferably not less than 10 μm, in terms of further improvement of the thermal conduction properties of resin and ease of handling. Further, for ease of uniform dispersion in a resin composition, the average particle diameter is preferably not more than 90 μm, more preferably not more than 70 μm, and even more preferably not more than 50 μm. The average particle diameter is a volume-based average particle diameter (D50).

In terms of higher crystallinity and further improvement of the thermal conduction properties of resin, the hexagonal boron nitride powder has a whiteness of preferably not less than 90. The whiteness is measured with use of a colorimeter.

### [Method for Producing Hexagonal Boron Nitride Powder]

A method for manufacturing hexagonal boron nitride powder in accordance with an aspect of the present invention (hereinafter also referred to as “the present manufacturing method”) includes a reduction nitridation step, an acid cleaning step, a heating step, a cooling step, and a recovery step. Each step is described below.

### (Reduction Nitridation Step)

In the reduction nitridation step, a raw material mixture containing an oxygen-containing boron compound, a carbon source, an oxygen-containing calcium compound, and a carbon-containing boron compound is heated in a furnace under a nitrogen atmosphere to a temperature of not less than 1500° C. and not more than 1850° C. at a heating rate of not more than 10° C./min. Through this step, hexagonal boron nitride containing an unreacted raw material can be obtained.

### (Raw Materials)

As the oxygen-containing boron compound, a compound containing boron and an oxygen atom may be used. Examples of the oxygen-containing boron compound include boric acid, boric acid anhydride, metaboric acid, perboric acid, hypoboric acid, sodium tetraborate, and sodium perborate. Among these, boric acid or boron oxide, which are easily available, may be preferably used.

Examples of the carbon source include crystalline carbons such as diamond, graphite, and nanocarbon; and pyrolytic carbons obtained by pyrolysis of monomers or polymers, in addition to amorphous carbons such as carbon black, activated carbon, and carbon fiber. Among them, the amorphous carbons, which are highly reactive, are preferable, and the carbon black is particularly suitably used, since its quality is industrially controlled. Examples of carbon black include acetylene black, furnace black, and thermal black.

Examples of the oxygen-containing calcium compound include calcium carbonate, calcium hydrogen carbonate, calcium hydroxide, calcium oxide, calcium nitrate, calcium sulfate, calcium phosphate, and calcium oxalate. It is also possible to use one type or two or more types of these mixed together. Among them, it is preferable to use calcium oxide or calcium carbonate. By including an oxygen-containing calcium compound in the raw material mixture, it is possible to obtain hexagonal boron nitride powder with high crystallinity when the oxygen-containing calcium compound is heated at a heating rate of not more than 10° C./min in the reduction nitridation step.

The oxygen-containing calcium compound plays a role in forming a complex oxide with the oxygen-containing boron compound to form a complex oxide having a high melting point and thus preventing the oxygen-containing boron compound from being volatilized. It has also been confirmed that it plays a role as a catalyst in a reaction that directly nitrides boron carbide.

As the carbon-containing boron compound, a compound containing carbon and boron (e.g., boron carbide) may be used. A particle diameter of the carbon-containing boron compound is preferably 1 μm to 500 μm, more preferably 10 μm to 400 μm, and even more preferably 20 μm to 300 μm.

The oxygen-containing boron compound, the carbon source, the oxygen-containing calcium compound, and the carbon-containing boron compound may be, for example, mixed in the ratio described below to obtain a mixture. The ratio B/C (element ratio) between a mass of the oxygen-containing boron compound in terms of B and a mass of the carbon source in terms of C is set to 0.75 to 1.05. The oxygen-containing calcium compound is set to an amount of 5 parts by mass to 20 parts by mass in terms of CaO to a total amount of 100 parts by mass of masses of the oxygen-containing boron compound in terms of B₂O₃ and the carbon source in terms of C. The carbon-containing boron compound is set to an amount of 5 parts by mass to 45 parts by mass to a total amount of 100 parts by mass of masses of the oxygen-containing boron compound, the carbon source, and the oxygen-containing calcium compound in terms of B₂O₃, C, and CaO, respectively.

The raw material mixture containing the raw materials may be supplied to the reduction nitridation reaction, for example, in the form of powder as it is or in the form of granulated products formed therefrom. The mixing of the raw materials can be carried out, for example, with use of a mixer such as a vibrating mill, a bead mill, a ball mill, a Henschel mixer, a drum mixer, a vibrating shaker, or a V-shaped mixer.

The heating of the raw material mixture in the reduction nitridation step is carried out in a furnace under a nitrogen atmosphere. Examples of a gas introduced into the furnace include nitrogen gas and ammonia gas. A gas obtained by mixing a non-oxidizing gas such as hydrogen, argon, or helium with nitrogen gas or ammonia gas may also be used. As the gas introduced into the heating furnace, nitrogen gas is preferred. The nitrogen gas is preferably nitrogen gas with a controlled dew point temperature, and the dew point temperature is preferably not higher than −85° C.

The heating of the raw material mixture in the reduction nitridation step is carried out from 1500° C. to a temperature of not more than 1850° C. (the maximum reduction nitridation temperature) at a heating rate of not more than 10° C./min. Heating at this heating rate allows a grain growth rate of the hexagonal boron nitride powder to be decreased, so that hexagonal boron nitride powder with high crystallinity can be obtained. To obtain hexagonal boron nitride powder with higher crystallinity by decreasing the grain growth rate of the hexagonal boron nitride powder, a heating rate in heating from 1500° C. to the maximum reduction nitridation temperature is preferably not more than 7° C./min, more preferably not more than 5° C./min, and even more preferably not more than 3° C./min.

During the reduction nitridation reaction, a retention time may be optionally provided as needed within a temperature range of up to 1500° C. After reaching the maximum reduction nitridation temperature, in terms of promoting the reduction nitridation reaction, the retention time for retaining the maximum reduction nitridation temperature is preferably not less than 1 hour, more preferably not less than 2 hours. Further, the retention time for retaining the maximum reduction nitridation temperature is preferably not more than 10 hours, more preferably not more than 5 hours.

The reduction nitridation step can be carried out with use of a known reaction device capable of controlling a reaction atmosphere. For example, one possible option is an atmosphere control-type high-temperature furnace in which heating treatment is performed by high-frequency induction heating or by heating with a heater, and a continuous heating furnace such as a pusher-type tunnel furnace and a vertical reaction furnace can be used as well as a batch furnace.

The hexagonal boron nitride powder after the reduction nitridation step may be adjusted to have a predetermined particle diameter distribution by carrying out disintegration. The disintegration is preferably carried out gently with use of, for example, a jet mill, a ball mill, a hammer mill, or a stone mill type pulverizer. The particle diameter of the powder after the disintegration may be adjusted as appropriate by a classification treatment through air classification or sieve treatment.

### (Acid Cleaning Step)

In the acid cleaning step, the hexagonal boron nitride powder containing an unreacted raw material obtained through the reduction nitridation step is cleaned with acid. The hexagonal boron nitride powder obtained through the reduction nitridation reaction contains an unreacted raw material such as an oxide or a metal impurity. Through the acid cleaning step, hexagonal boron nitride powder from which the unreacted raw material has been removed can be obtained.

A method for the acid cleaning of the hexagonal boron nitride powder containing an unreacted raw material is not particularly limited, and a known method may be employed without limitation. For example, one possible method is as follows. After the reduction nitridation reaction, the obtained hexagonal boron nitride powder containing an unreacted raw material is introduced into a container, and dilute hydrochloric acid (10% by mass to 20% by mass of HCl) in an amount 5 to 10 times that of the hexagonal boron nitride powder containing the unreacted raw material is added to the container to bring them into contact for 4 hours to 8 hours.

The acid used in the acid cleaning can be, for example, nitric acid, sulfuric acid, or acetic acid, as well as the hydrochloric acid.

After the acid cleaning, water cleaning using pure water may be carried out in order to clean the remaining acid away. The method for the water cleaning may involve filtering out the acid used in the acid cleaning, then dispersing, in the same amount of pure water as that of the acid used, the hexagonal boron nitride powder that has been subjected to the acid cleaning, and carrying out filtering again.

Water-containing agglomerates may be dried after the acid cleaning or the water cleaning. The drying is preferably carried out under a condition, e.g., in an atmosphere at 50° C. to 250° C. or under reduced pressure at 50° C. to 250° C. The drying time is not particularly specified, but the drying is preferably carried out until the water content is as close to 0% as possible.

### (Heating Step)

In the heating step, the hexagonal boron nitride powder obtained through the acid cleaning step is heated to a temperature of more than 1850° C. and less than 2050° C. at a heating rate of not more than 5° C./min.

The heating step may be carried out under a nitrogen atmosphere. The supplying of the nitrogen source to the reaction system in the heating step may be performed by a method similar to that in the reduction nitridation step. Further, a reaction device similar to the reaction device used in the reduction nitridation step may be used.

The heating of the hexagonal boron nitride powder in the heating step is carried out at a heating rate of not more than 5° C./min, to a temperature of more than 1850° C. and less than 2050° C. (maximum re-firing temperature). Through this heating, it is possible to obtain hexagonal boron nitride powder with high crystallinity. However, if the heating is carried out to a temperature of not less than 2050° C., there is a risk that the hexagonal boron nitride powder will yellow due to nitrogen defects or other factors and have low crystallinity.

A temperature at which adjustment of the heating rate is started in the heating step is not particularly limited and may be, for example, room temperature (20° C. to 25° C.).

From the standpoint of, for example, improving efficiency in the heating step, it is preferable that the temperature at which the adjustment of the heating rate is started be at least 1450° C. The phrase “the temperature at which the adjustment of the heating rate is started be at least 1450° C.” encompasses a case in which the adjustment of the heating rate is started after the hexagonal boron nitride powder reaches a temperature of 1450° C.

To obtain hexagonal boron nitride powder with higher crystallinity, the heating rate in the heating step is preferably not more than 4° C./min, and more preferably not more than 3° C./min.

To sufficiently perform the heating (re-firing) of the hexagonal boron nitride powder after reaching the maximum re-firing temperature, the retaining time for retaining the maximum re-firing temperature is preferably not less than 1 hour, and more preferably not less than 3 hours. Further, the retention time for retaining the maximum re-firing temperature is preferably not more than 15 hours, and more preferably not more than 10 hours.

### (Cooling Step)

In the cooling step, the hexagonal boron nitride powder after the above-described heating step is cooled at a cooling rate of not more than 5° C./min to a temperature of at least 1550° C. Through this cooling step, it is possible to obtain hexagonal boron nitride powder having a ratio of a CL spectral intensity at 227 nm to a CL spectral intensity at 330 nm of not less than 1.0.

Cooling to a temperature of at least 1550° C. encompasses cooling the hexagonal boron nitride powder to a temperature of 1550° C.

To obtain hexagonal boron nitride powder with a higher ratio of a CL spectral intensity at 227 nm to a CL spectral intensity at 330 nm, the heating rate in the cooling step is preferably not more than 4° C./min, and more preferably not more than 3° C./min.

### (Recovery Step)

In the recovery step, after the above-described cooling step, the hexagonal boron nitride powder which has been cooled to a temperature of not more than 50° C. is removed from the furnace. By cooling the hexagonal boron nitride powder to be recovered from the furnace to a temperature of not more than 50° C., it is possible to suppress reaction with moisture in the air. The suppression of reaction makes it possible to inhibit an increase in the surface oxygen concentration (B₂O₃ concentration) of the hexagonal boron nitride powder and improve the crystallinity of the hexagonal boron nitride powder. Furthermore, by cooling the hexagonal boron nitride powder to be recovered from the furnace to a temperature of not more than 50° C., it is possible to obtain hexagonal boron nitride powder having a ratio of a CL spectral intensity at 227 nm to a CL spectral intensity at 330 nm of not more than 1.0.

To sufficiently suppress reaction with moisture in the air and improve the crystallinity of the hexagonal boron nitride powder, the temperature of the hexagonal boron nitride powder recovered from the furnace is preferably not more than 40° C., and more preferably not more than 30° C.

### [Use of Hexagonal Boron Nitride Powder]

### (Resin Composition)

A resin composition in accordance with an aspect of the present invention contains the above-described hexagonal boron nitride powder. By containing the hexagonal boron nitride powder, the resin composition exhibits high thermal conduction properties and is suitable for heat dissipation applications.

The above resin composition can be used for various applications. By mixing the resin composition with a resin described later to form a thermally conductive resin composition or a thermally conductive molded product, it can be preferably used, for example, for applications such as: thermal interface materials such as a polymer-based heat dissipation sheet and a phase change sheet; organic heat dissipation sheets such as a heat dissipation tape, a heat dissipation grease, a heat dissipation adhesive, and a gap filler; heat dissipation paints such as a heat dissipation paint and a heat dissipation coating; heat dissipation resin substrates such as a PWB-based resin substrate and a CCL-based resin substrate; insulating layers for metal-based substrates such as an aluminum-based substrate and a copper-based substrate; and sealing materials for power devices.

Examples of the resin contained in the resin composition include thermoplastic resins such as polyolefin, vinyl chloride resin, methyl methacrylate resin, nylon, and fluorine resin; thermosetting resins such as epoxy resin, phenolic resin, urea resin, melamine resin, unsaturated polyester resin, silicon resin, and bismaleimide triazine resin; and synthetic rubbers.

The resin composition may contain a thermally conductive filler, such as aluminum nitride and aluminum oxide, which are known highly thermally conductive insulating fillers.

The resin composition may further contain, for example, a polymerization initiator, a curing agent, a polymerization inhibitor, a polymerization retardant, a coupling agent, a plasticizer, an ultraviolet light absorber, a pigment, a dye, an antibacterial agent, organic an filler, and an organic/inorganic composite filler which are known as compounding agents for the resin composition, according to need. The resin composition may also contain other inorganic fillers to an extent that does not impair the effects of the present invention.

In the resin composition, a content of the hexagonal boron nitride powder is preferably 20% by volume to 80% by volume, and more preferably 30% by volume to 70% by volume, in terms of achieving higher thermal conduction properties.

A content of the resin in the resin composition corresponds to a remaining volume after subtracting the content of the hexagonal boron nitride powder from 100% by volume of a total volume of the resin composition. The remaining volume includes a volume of a curing agent in a case where the curing agent is included, and is preferably 80% by volume to 20% by volume, and more preferably 70% by volume to 30% by volume.

### (Resin Sheet)

A resin sheet in accordance with an aspect of the present invention is composed of the above resin composition. Applications of the resin sheet are not particularly limited, but the resin sheet can be used, for example, for applications such as a circuit board and heat dissipation of an electronic component such as a multilayer printed wiring board.

A method for producing the resin sheet is not particularly limited. For instance, in a case where the resin is a curable epoxy resin, a resin sheet production method may be employed which includes a mixing step of obtaining a curable composition by mixing the curable epoxy resin, the above hexagonal boron nitride powder, and other components as needed; a molding step of shaping the curable composition into a desired shape; and a curing step of curing the curable composition.

### (Other Applications)

The hexagonal boron nitride powder in accordance with an aspect of the present invention, due to its high crystallinity, can also be used for applications such as: raw materials for processed boron nitride products such as cubic boron nitride or boron nitride molded products; nucleating agents for engineering plastics; phase change materials; solid or liquid thermal interface materials; mold releasing agents for molten metal molds or molten glass molds; cosmetics; and composite ceramic raw materials.

Aspects of the present invention can also be expressed as follows:

Hexagonal boron nitride powder in accordance with Aspect 1 of the present invention has a ratio of a spectral intensity at a wavelength of 227 nm to a spectral intensity at a wavelength of 330 nm of not less than 1.0, as measured by a cathodoluminescence method.

Hexagonal boron nitride powder in accordance with Aspect 2 of the present invention may be configured such that, in Aspect 1 of the present invention, an amount of boron eluted from the hexagonal boron nitride powder is not more than 250 ppm in terms of B₂O₃, as measured after the hexagonal boron nitride powder is immersed in a 2 mol/L aqueous sulfuric acid solution at 25° C. for 120 minutes.

Hexagonal boron nitride powder in accordance with Aspect 3 of the present invention may be configured such that, in Aspect 1 or 2 of the present invention, the hexagonal boron nitride powder has an average particle diameter of not less than 2 μm and not more than 150 μm.

A resin composition in accordance with Aspect 4 of the present invention contains the hexagonal boron nitride powder in accordance with any one of Aspects 1 to 3 of the present invention.

A resin sheet in accordance with Aspect 5 of the present invention is a resin sheet composed of the resin composition in accordance with Aspect 4 of the present invention.

A method for producing hexagonal boron nitride powder in accordance with Aspect 6 of the present invention includes: (1) a reduction nitridation step of obtaining hexagonal boron nitride by heating a raw material mixture in a furnace under a nitrogen atmosphere to a temperature of not less than 1500° C. and not more than 1850° C. at a heating rate of not more than 10° C./min, the raw material mixture containing an oxygen-containing boron compound, a carbon source, an oxygen-containing calcium compound, and a carbon-containing boron compound; (2) an acid cleaning step of cleaning, with acid, the hexagonal boron nitride powder which has been obtained through the reduction nitridation step and which contains an unreacted raw material; (3) a heating step in which the hexagonal boron nitride powder after the acid cleaning step is heated to a temperature of more than 1850° C. and less than 2050° C. at a heating rate of not more than 5° C./min; (4) a cooling step in which the hexagonal boron nitride powder after the heating step is cooled at a cooling rate of not more than 5° C./min to a temperature of at least 1550° C.; and (5) a recovery step in which the hexagonal boron nitride powder which has been cooled to a temperature of not more than 50° C. is removed from the furnace after the cooling step.

A method for producing hexagonal boron nitride powder in accordance with Aspect 7 of the present invention may be configured such that, in Aspect 6 of the present invention, adjustment of the heating rate in the heating step is carried out from a temperature of at least 1450° C.

The following provides Examples to describe the embodiments of the present invention in further detail. Of course, the present invention is not limited to the Examples below, and it goes without saying that details of the present invention can have various aspects. The present invention is not limited to the description of the embodiments above, but may be altered in various ways by a skilled person within the scope of the claims. The present invention encompasses, in its technical scope, any embodiment derived by appropriately combining technical means disclosed in the differing embodiments. All documents cited in the present specification are incorporated herein by reference.

### EXAMPLES

### [Preparation Example 1] Preparation of Hexagonal Boron Nitride Powder

259 g of a mixture containing 141 g of boron oxide, 56 g of carbon black, 32 g of calcium oxide, and 30 g of boron carbide was mixed with use of a ball mill. The mixture was subjected to a reduction nitridation treatment (reduction nitridation step) with use of a graphite Tamman furnace such that, under a nitrogen gas atmosphere, the mixture was heated to 1500° C., then retained at 1500° C. for 4 hours, then heated to a maximum reduction nitridation temperature of 1850° C. at a rate of 2° C./min, and then retained at 1850° C. for 2 hours.

The hexagonal boron nitride powder after the reduction nitridation treatment was introduced into a container, and hydrochloric acid (7% by mass of HCl) in an amount 5 times that of the hexagonal boron nitride powder was added to the container. The mixture was stirred at a rotation speed of 700 rpm for 24 hours to perform acid cleaning treatment (acid cleaning step). After the acid cleaning treatment, the acid was filtered out. The hexagonal boron nitride powder obtained through the filtration was dispersed into the same amount of pure water as that of the acid used, and filtering was carried out again. This operation was repeated 5 times, and then drying was carried out in vacuum at 200° C. for 6 hours.

The obtained hexagonal boron nitride powder after drying was subjected to a re-firing treatment (heating step) with use of a graphite Tamman furnace such that, under a nitrogen gas atmosphere, the hexagonal boron nitride powder was heated to 1500° C., then further heated to a maximum re-firing temperature of 1950° C. at a rate of 2° C./min, and then retained at 1950° C. for 6 hours.

Subsequently, nitrogen gas was caused to flow into the furnace to cool the hexagonal boron nitride powder to 1500° C. at a rate of 1° C./min (cooling step). Then, more nitrogen gas was caused to flow into the furnace to cool the inside of the furnace to 25° C., and then the hexagonal boron nitride powder was recovered from the furnace (recovery step).

### [Example 2] Preparation of Hexagonal Boron Nitride Powder

Hexagonal boron nitride powder was prepared following the same procedure as in Example 1, except that the cooling rate in the cooling step was changed to 2° C./min.

### [Example 3] Preparation of Hexagonal Boron Nitride Powder

Hexagonal boron nitride powder was prepared following the same procedure as in Example 1, except that the maximum re-firing temperature in the heating step was set to 2010° C.

### [Example 4] Preparation of Hexagonal Boron Nitride Powder

Hexagonal boron nitride powder was prepared following the same procedure as in Example 1, except that the cooling rate in the cooling step was changed to 3° C./min.

### [Example 5] Preparation of Hexagonal Boron Nitride Powder

Hexagonal boron nitride powder was prepared following the same procedure as in Example 1, except that the maximum re-firing temperature in the heating step was set to 1900° C.

### [Comparative Example 1] Preparation of Hexagonal Boron Nitride Powder

Hexagonal boron nitride powder was prepared following the same procedure as in Example 1, except that the maximum re-firing temperature in the heating step was set to 2050° C.

### [Comparative Example 2] Preparation of Hexagonal Boron Nitride Powder

Hexagonal boron nitride powder was prepared through only the reduction nitridation step and the acid cleaning step described in Example 1. Note that the heating from 1500° C. to 1850° C. in the reduction nitridation step was performed at a rate of 1° C./min. Other than this, the conditions for the reduction nitridation step and the acid cleaning step were the same as those in Example 1.

### [Comparative Example 3] Preparation of Hexagonal Boron Nitride Powder

Hexagonal boron nitride powder was prepared following the same procedure as in Example 1, except that the cooling rate in the cooling step was changed to 10° C./min.

### Comparative Example 4

Hexagonal boron nitride powder was prepared following the same procedure as in Example 1, except that the maximum firing temperature in the heating step was set to 1800° C.

### Comparative Example 5

Hexagonal boron nitride powder was prepared following the same procedure as in Example 1, except that the heating from 1500° C. to 1850° C. in the reduction nitridation step was performed at a rate of 15° C./min.

### Comparative Example 6

Hexagonal boron nitride powder was prepared following the same procedure as in Example 1, except that, in the recovery step, the hexagonal boron nitride powder was recovered from the furnace after the inside of the furnace was cooled to 100° C.

### Comparative Example 7

Hexagonal boron nitride powder was prepared following the same procedure as in Example 1, except that the reduction nitridation step was performed by a melamine method through thermal decomposition of melamine borate at 1950° C.

### [Evaluation Example 1] Evaluation of Hexagonal Boron Nitride Powder

Hexagonal boron nitride powder obtained in each of Examples 1 to 5 and Comparative Examples 1 to 7 was evaluated using the following evaluation methods.

### (Measurement Using Cathodoluminescence (CL) Method)

Measurement using the CL method was conducted under the following conditions, using a Schottky emission-type SEM, S-4300SE, manufactured by HITACHI, Ltd., and a spectrometer HR-320 (manufactured by HORIBA, Ltd.).
Electron beam acceleration voltage: 5 kV
Sample temperature: 296 K
Measurement area: 50×50 μm² (measured at three points by changing the locations)

### (Measurement of Amount of Total Oxygen Contained)

A total oxygen content in the hexagonal boron nitride powder was measured using an analyzer EMGA-620 W for analyzing oxygen and nitrogen in ceramics, manufactured by HORIBA, Ltd.

### (Measurement of Amount of Total Carbon Contained)

A total carbon content in the hexagonal boron nitride powder was measured using an analyzer EMIA-110 for analyzing carbon in ceramics, manufactured by HORIBA, Ltd. The powder was combusted in an oxygen stream, and the total carbon content was quantified based on the amounts of CO gas and CO₂ gas generated.

(Measurement of B₂O₃ Concentration)

Into 50-mL IBOY, 50 g of 2% aqueous sulfuric acid solution and 2 g of the hexagonal boron nitride powder were introduced and then were subjected to vibration stirring for one minute while adjusting the temperature of the solution to 25° C. Thereafter, the solution was left to stand for 120 minutes, and then a boron content in the solution thus obtained was analyzed with use of an ICP optical emission spectrometer (iCAP6500, manufactured by THERMO FISHER Inc.). A measurement result thus obtained was divided by a mass of the hexagonal boron nitride powder used for the test, to calculate an amount of boron eluted (B₂O₃ concentration, ppm) per unit mass of the hexagonal boron nitride powder.

### (Measurement of Whiteness)

Whiteness of the hexagonal boron nitride powder was measured using a colorimeter ZE7700 (manufactured by NIPPON DENSHOKU INDUSTRIES CO., LTD.).

### (Average Particle Diameter)

The average particle diameter (volume-based average particle diameter (D50)) of the hexagonal boron nitride powder was measured by laser diffractometry with use of a laser diffraction/scattering type particle diameter measurement device MT3000 (manufactured by MicrotracBEL Corp.).

### [Evaluation Example 1] Evaluation of Thermal Conductivity of Resin Compositions

Epoxy resin was filled with the hexagonal boron nitride powder obtained in each Example or Comparative Example to prepare a resin composition, which was then evaluated for thermal conductivity. As the epoxy resin, a mixture of 100 parts by mass of JER828 manufactured by Mitsubishi Chemical Corporation, 5 parts by mass of a curing agent (imidazole-based curing agent; CUREZOL 2E4MZ manufactured by SHIKOKU CHEMICALS CORPORATION), and 210 parts by mass of methyl ethyl ketone serving as a solvent was prepared. Subsequently, a resin composition was obtained by mixing the mixture in the form of varnish and the hexagonal boron nitride powder with use of a planetary centrifugal mixer (MAZERUSTAR manufactured by Kurabo Industries Ltd.) so that the base resin and the specific boron nitride powder respectively accounted for 35% by volume and 65% by volume, or the base resin and the specific boron nitride powder respectively accounted for 40% by volume and 63% by volume, or the base resin and the specific boron nitride powder respectively accounted for 45% by volume and 55% by volume.

The resin composition was coated on a PET film so as to have a thickness of approximately 180 μm to 220 μm with use of an automatic coating machine PI-1210 manufactured by Tester Sangyo Co., Ltd., and was dried. The resin composition was then cured under reduced pressure, under conditions of a temperature of 200° C., a pressure of 5 MPa, and a retention time of 30 minutes, so as to prepare a sheet with a thickness of 150 μm. The sheet was analyzed with use of a temperature wave heat analyzing device, and a thermal conductivity was calculated.

The production conditions of the hexagonal boron nitride powder in each Example or Comparative Example, as well as evaluation results of Evaluation Example 1, are shown in Table 1.

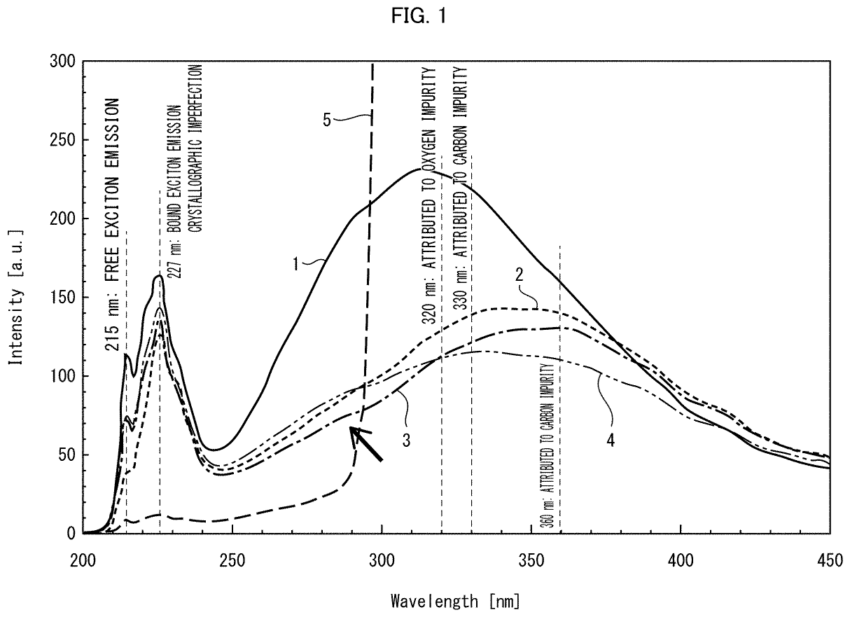

The measured CL spectra are shown in FIG. 1. In FIG. 1, “1” represents the measurement results of the hexagonal boron nitride powder of Comparative Example 2. “2” represents the measurement results of the hexagonal boron nitride powder of Example 4. “3” represents the measurement results of the hexagonal boron nitride powder of Example 2. “4” represents the measurement results of the hexagonal boron nitride powder of Example 1. “5” represents the measurement results of the hexagonal boron nitride powder of Comparative Example 1.

TABLE 1

| | Production method | | | | Hexagonal boron nitride powder | | | | | | |
|---|---|---|---|---|---|---|---|---|---|---|---|
| | Reduction | | | | 227 nm/ | | | | | | Resin |
| | nitridation | Maximum | | | 330 nm | | | B₂O₃ | | Average | composition |
| | heating | re-firing | Cooling | Removal | CL peak | Total | Total | (surface | | particle | Thermal |
| | rate | temperature | rate | temperature | intensity | oxygen | carbon | oxygen) | | diameter | conductivity |
| | ° C./min | ° C. | ° C./min | ° C. | ratio | % | % | ppm | Whiteness | μm | W/m · K |
| Ex. 1 | 2 | 1950 | 1 | 25 | 1.3 | 0.05 | 0.03 | 150 | 98 | 30 | 20 |
| Ex. 2 | 2 | 1950 | 2 | 25 | 1.2 | 0.05 | 0.04 | 100 | 98 | 30 | 18 |
| Ex. 3 | 2 | 2010 | 1 | 25 | 1.4 | 0.01 | 0.02 | 160 | 96 | 50 | 21 |
| Ex. 4 | 2 | 1950 | 3 | 25 | 1.0 | 0.06 | 0.05 | 150 | 98 | 30 | 17 |
| Ex. 5 | 2 | 1900 | 1 | 25 | 1.1 | 0.05 | 0.02 | 100 | 94 | 30 | 18 |
| Comp. | 2 | 2050 | 1 | 25 | 0.2 | 0.03 | 0.03 | 100 | 88 | 30 | 15 |
| Ex. 1 | | | | | | | | | | | |
| Comp. | 1 | — | — | — | 0.6 | 0.07 | 0.04 | 100 | 92 | 40 | 13 |
| Ex. 2 | | | | | | | | | | | |
| Comp. | 2 | 1950 | 10 | 25 | 0.9 | 0.05 | 0.02 | 100 | 95 | 25 | 15 |
| Ex. 3 | | | | | | | | | | | |
| Comp. | 2 | 1800 | 1 | 25 | 0.9 | 0.06 | 0.02 | 100 | 96 | 25 | 15 |
| Ex. 4 | | | | | | | | | | | |
| Comp. | 15 | 1950 | 1 | 25 | 0.8 | 0.05 | 0.04 | 125 | 90 | 30 | 14 |
| Ex. 5 | | | | | | | | | | | |
| Comp. | 2 | 1950 | 1 | 100 | 0.9 | 0.05 | 0.04 | 300 | 93 | 30 | 15 |
| Ex. 6 | | | | | | | | | | | |
| Comp. | Melamine | 1950 | 1 | 25 | 0.8 | 0.05 | 0.04 | 150 | 92 | 30 | 14 |
| Ex. 7 | method | | | | | | | | | | |

In Table 1, “Reduction nitridation heating rate” indicates a rate of heating from 1500° C. to the maximum re-firing temperature in the reduction nitridation step. “Cooling rate” indicates a rate of cooling from the maximum re-firing temperature to 1500° C. in the cooling step. “Removal temperature” indicates a temperature inside the furnace when the re-fired hexagonal boron nitride powder is recovered from the furnace. “227 nm/330 nm” indicates a ratio of a CL peak intensity at a wavelength of 227 nm to a CL peak intensity at a wavelength of 330 nm.

As shown in Table 1, the resin composition containing the hexagonal boron nitride powder of each of the Examples, in which the ratio of the CL peak intensity at 227 nm to the CL peak intensity at 330 nm was not less than 1.0, had a thermal conductivity of more than 15 W/m·K. This indicates that the hexagonal boron nitride powder of each of the Examples is suitable as a heat-dissipating filler.

In Comparative Example 1, in which the maximum re-firing temperature was 2050° C., the ratio of the CL peak intensity at 227 nm to the CL peak intensity at 330 nm was as low as 0.2, and the powder exhibited yellowing. Yellowed powder suffers nitrogen defects and the like and exhibits poor crystallinity. The resin composition containing the hexagonal boron nitride powder of Comparative Example 4, in which the maximum re-firing temperature was 1850° C., had a thermal conductivity of not more than 15 W/m·K. This suggests that a purification effect of re-firing was not achieved.

In each of Comparative Examples 3 and 5, in which the heating rate during the heating step (re-firing) or the cooling rate during the cooling step was high, the ratio of the CL peak intensity at 227 nm to the CL peak intensity at 330 nm was 0.9, and the thermal conductivity of the resin composition was not more than 15 W/m·K. These results indicate that the heating rate and the cooling rate during re-firing affect the ratio of the CL peak intensity at 227 nm to the CL peak intensity at 330 nm and the thermal conductivity of the resin composition.

Regarding the hexagonal boron nitride powder of Comparative Example 6, in which the removal temperature for the hexagonal boron nitride powder was high, the following considerations can be made. The hexagonal boron nitride powder reacted with moisture in the air to have an increase in surface oxygen concentration. As a result, the hexagonal boron nitride powder had a decrease in crystallinity on the surface thereof, and had a low ratio of the CL peak intensity at 227 nm to the CL peak intensity at 330 nm.

### INDUSTRIAL APPLICABILITY

The hexagonal boron nitride powder in accordance with an embodiment of the present invention has high crystallinity, improves the thermal conduction properties of resins, and can be used as a raw material for materials employed in electronic components.

1. Hexagonal boron nitride powder having a ratio of a spectral intensity at a wavelength of 227 nm to a spectral intensity at a wavelength of 330 nm of not less than 1.0, as measured by a cathodoluminescence method.

2. The hexagonal boron nitride powder as set forth in claim 1, wherein an amount of boron eluted from the hexagonal boron nitride powder is not more than 250 ppm in terms of B₂O₃, as measured after the hexagonal boron nitride powder is immersed in a 2 mol/L aqueous sulfuric acid solution at 25° C. for 120 minutes.

3. The hexagonal boron nitride powder as set forth in claim 1, having an average particle diameter of not less than 2 μm and not more than 150 μm.

4. A resin composition comprising hexagonal boron nitride powder recited in claim 1.

5. A resin sheet composed of a resin composition recited in claim 4.

6. A method for producing hexagonal boron nitride powder, the method comprising:
(1) a reduction nitridation step of obtaining hexagonal boron nitride by heating a raw material mixture in a furnace under a nitrogen atmosphere to a temperature of not less than 1500° C. and not more than 1850° C. at a heating rate of not more than 10° C./min, the raw material mixture containing an oxygen-containing boron compound, a carbon source, an oxygen-containing calcium compound, and a carbon-containing boron compound;
(2) an acid cleaning step of cleaning, with acid, the hexagonal boron nitride powder which has been obtained through the reduction nitridation step and which contains an unreacted raw material;
(3) a heating step in which the hexagonal boron nitride powder after the acid cleaning step is heated to a temperature of more than 1850° C. and less than 2050° C. at a heating rate of not more than 5° C./min;
(4) a cooling step in which the hexagonal boron nitride powder after the heating step is cooled at a cooling rate of not more than 5° C./min to a temperature of at least 1550° C.; and
(5) a recovery step in which the hexagonal boron nitride powder which has been cooled to a temperature of not more than 50° C. is removed from the furnace after the cooling step.

7. The method as set forth in claim 6, wherein adjustment of the heating rate in the heating step is carried out from a temperature of at least 1450° C.
